(19) United States
(12) Patent Application Publication
(10) Pub. No.: US 2007/0293211 A1
(43) Pub. Date: Dec. 20, 2007

(54) METHOD FOR INFORMING OF AN INCOMING CALL AND RELATED WIRELESS COMMUNICATION DEVICE THEREOF

(76) Inventors: Hsin-Nan Yang, Chang-Hua City (TW); Tian-Tso Shen, Yun-Lin County (TW)

Correspondence Address: NORTH AMERICA INTELLECTUAL PROPERTY CORPORATION, P.O. BOX 506, MERRIFIELD, VA, 22116, US

(21) Appl. No.: 11/758,008

(22) Filed: Jun. 5, 2007

(30) Foreign Application Priority Data
Jun. 15, 2006 (TW) 095121442

(51) Int. Cl. H04M 3/00

(52) U.S. Cl. 455/420

(57) ABSTRACT

A method for informing of an incoming call includes: (a) sending a message from a first wireless communication device to a second wireless communication device; (b) setting a notification of incoming calls from the first wireless communication device in the second wireless communication device according to the message; and (c) the second wireless communication device executing the notification of incoming calls from the first wireless communication device when the second wireless communication device receives an incoming call from the first wireless communication device.

### BACKGROUND OF THE INVENTION

1. Field of the Invention

The present invention relates to a method for informing of an incoming call and related wireless communication device, and more particularly, to a method for setting a notification of incoming calls from other wireless communication devices in a wireless communication device according to a special message transmitted from other wireless communication devices and related wireless communication device.

2. Description of the Prior Art

Nowadays mobile phones have become very popular because of the decreasing price and the improvement of technology. More and more mobile phones enter the market. Manufacturers also add more additional features and functions in their mobile phones to satisfy all kinds of consumers, like sending personal texts and images to another mobile phone, browsing the internet, receiving and sending emails, listening to the radio, and even providing image capturing function by an internal or external phone camera and sending photos by MMS. In general, a user can set a notification of an incoming call from other user's mobile phone in his/her mobile phone. For example, the user can set a specific ringtone or a specific picture for an incoming call from a corresponding friend's mobile phone. When the user answers the incoming call from the friend's mobile phone, the user's mobile phone will play the specific ringtone or display the specific picture. However the user only can set a notification of an incoming call from other user's mobile phone in the user's own mobile phone. That is, a caller can not set a notification of an incoming call from the caller in a receiver's mobile phone. The user can not personalize the notification of the incoming call of one's own in other user's mobile phone.

### SUMMARY OF THE INVENTION

It is therefore a primary objective of the claimed invention to provide a method for informing of an incoming call and related wireless communication device for solving the above-mentioned problem.

According to the claimed invention, a method for informing of an incoming call includes: (a) sending a message from a first wireless communication device to a second wireless communication device; (b) setting a notification of incoming calls from the first wireless communication device in the second wireless communication device according to the message; and (c) the second wireless communication device executing the notification of incoming calls from the first wireless communication device when the second wireless communication device receives an incoming call from the first wireless communication device.

In one aspect of the present invention, step (a) includes the first wireless communication device sending a multimedia messaging service (MMS) message with a multimedia datum to the second wireless communication device.

In another aspect of the present invention, the multimedia datum is an image datum.

In another aspect of the present invention, step (b) includes setting the notification of incoming calls from the first wireless communication device as displaying the image datum in the second wireless communication device and step (c) includes the second wireless communication device displaying the image datum when the second wireless communication device receives the incoming call from the first wireless communication device.

In another aspect of the present invention, the multimedia datum is a ringtone datum.

In another aspect of the present invention, step (b) includes setting the notification of incoming calls from the first wireless communication device as playing the ringtone datum in the second wireless communication device and step (c) includes the second wireless communication device playing the ringtone datum when the second wireless communication device receives the incoming call from the first wireless communication device.

In another aspect of the present invention, the method further includes the second wireless communication device determining whether the message is a message for setting the notification of incoming calls from the first wireless communication device.

In another aspect of the present invention, the method further includes selecting whether the notification of incoming calls from the first wireless communication device is set in the second wireless communication device according to the message.

According to the claimed invention, a wireless communication device for setting a notification of incoming calls from a first wireless communication device according to a message transmitted from the first wireless communication device is disclosed. The wireless communication device includes a wireless communication module for receiving the message transmitted from the first wireless communication device and an incoming call from the first wireless communication device, a notification module for executing an notification of incoming calls, and a control unit for controlling the notification module to execute the notification of incoming calls from the first wireless communication device according to the message transmitted from the first wireless communication device when the wireless communication module receives an incoming call from the first wireless communication device.

In one aspect of the present invention, the message is a multimedia messaging service (MMS) message with a multimedia datum.

In another aspect of the present invention, the multimedia datum is an image datum.

In another aspect of the present invention, the notification module includes a display monitor and the control unit controls the display monitor to display the image datum when the wireless communication module receives the incoming call from the first wireless communication device.

In another aspect of the present invention, the multimedia datum is a ringtone datum.

In another aspect of the present invention, the notification module includes a speaker and the control unit controls the speaker to play the ringtone datum when the wireless communication module receives the incoming call from the first wireless communication device.

In another aspect of the present invention, the wireless communication device further includes a memory module for storing the message.

In another aspect of the present invention, the wireless communication device is a mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a first wireless communication device and a second wireless communication device according to an embodiment of the present invention.

FIG. 2 is a flowchart of the second wireless communication device setting a notification of incoming calls from the first wireless communication device according to a message transmitted from the first wireless communication device according to the embodiment of the present invention.

### DETAILED DESCRIPTION

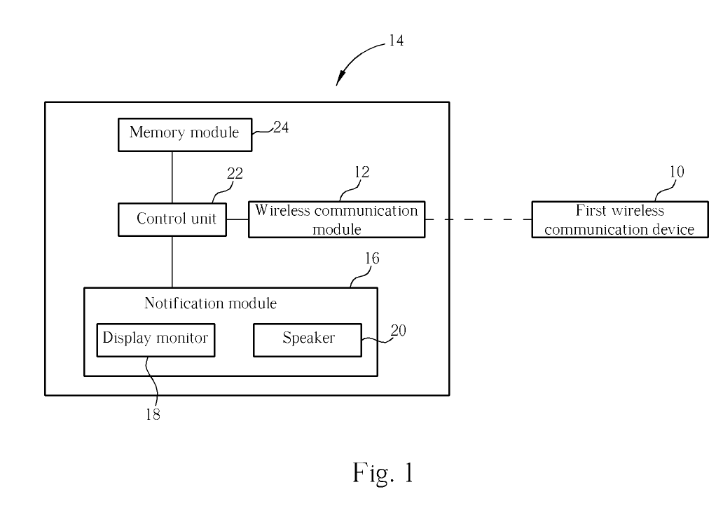

Please refer to FIG. 1. FIG. 1 is a functional block diagram of a first wireless communication device 10 and a second wireless communication device 14 according to an embodiment of the present invention. The second wireless communication device 14 can be a mobile phone or a personal digital assistant (PDA). The second wireless communication device 14 includes a wireless communication module 12 for receiving a message transmitted from the first wireless communication device 10 and an incoming call from the first wireless communication device 10, and a notification module 16 for executing an notification of incoming calls. The notification module 16 includes a display monitor 18 and a speaker 20. The second wireless communication device 14 further includes a control unit 22 for controlling the notification module 16 to execute an notification of incoming calls from the first wireless communication device 10 according to the message transmitted from the first wireless communication device 10 when the wireless communication module 12 of the second wireless communication device 14 receives an incoming call from the first wireless communication device 10. The second wireless communication device 14 further includes a memory module 24 for storing the message. The message can be a multimedia messaging service (MMS) message with a multimedia datum. The multimedia datum can be an image datum, a ringtone datum, and so on.

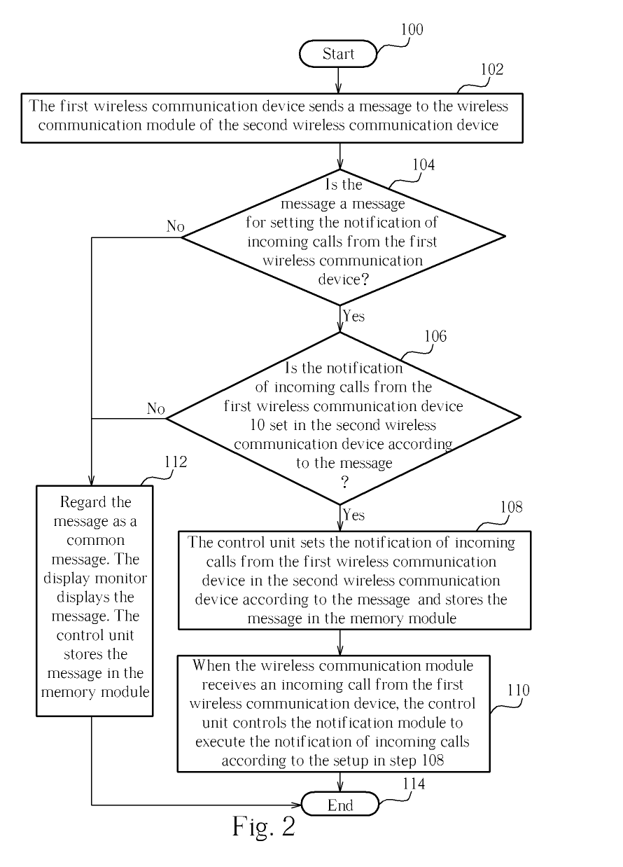

Please refer to FIG. 2. FIG. 2 is a flowchart of the second wireless communication device 14 setting a notification of incoming calls from the first wireless communication device 10 according to a message transmitted from the first wireless communication device 10 according to the embodiment of the present invention. The method includes following steps:

Step 102: The first wireless communication device 10 sends a message to the wireless communication module 12 of the second wireless communication device 14.

Step 104: The control unit 22 of the second wireless communication device 14 determines whether the message is a message for setting the notification of incoming calls from the first wireless communication device 10. If yes, go to step 106; if no, go to step 112.

Step 106: Select whether the notification of incoming calls from the first wireless communication device 10 is set in the second wireless communication device 14 according to the message. If yes, go to step 108; if no, go to step 112.

Step 108: The control unit 22 sets the notification of incoming calls from the first wireless communication device 10 in the second wireless communication device 14 according to the message and stores the message in the memory module 24.

Step 110: When the wireless communication module 12 of the second wireless communication device 14 receives an incoming call from the first wireless communication device 10, the control unit 22 controls the notification module 16 to execute the notification of incoming calls according to the setup in step 108.

Step 112: Regard the message as a common message instead of a message for setting a notification of incoming calls. The display monitor 18 displays the message. The control unit 22 stores the message in the memory module 24.

Step 114: End.

The detailed description is introduced as follow. First the first wireless communication device 10 sends a multimedia messaging service (MMS) message with a multimedia datum to the wireless communication module 12 of the second wireless communication device 14. The multimedia datum can be an image datum corresponding to the first wireless communication device 10, a ringtone datum corresponding to the first wireless communication device 10, and so on. The control unit 22 of the second wireless communication device 14 determines whether the message is a message for setting the notification of incoming calls from the first wireless communication device 10. For example, a data field of the message can include an identification code so as to define the message as a message for setting the notification of incoming calls. When the control unit 22 recognizes the identification code in the data field of the message, the control unit 22 determines the message is the message for setting the notification of incoming calls from the first wireless communication device 10. On the contrary, when the control unit 22 does not recognize the identification code in the data field of the message, the control unit 22 determines the message is not the message for setting the notification of incoming calls from the first wireless communication device 10 and regards the message as a common message. The control unit 22 controls the display monitor 18 to display the message and stores the message in the memory module 24. When the message is the message for setting the notification of incoming calls but the second wireless communication device 14 does not support a corresponding function of setting the notification of incoming calls, the second wireless communication device 14 requests the user to contact a telecommunication service center or to browse a telecommunication service website to get further information about the function of setting the notification of incoming calls.

When the message is the message for setting the notification of incoming calls and the second wireless communication device 14 supports a corresponding function of setting the notification of incoming calls, the control unit 22 controls the display monitor 18 to display a frame to query whether the user wants to set the notification of incoming calls from the first wireless communication device 10 in the second wireless communication device 14. If the user chooses no, the control unit 22 regards the message as a common message. The control unit 22 controls the display monitor 18 to display the message directly and stores the message in the memory module 24. If the user chooses yes, the control unit 22 regards the message as a message for setting the notification of incoming calls. The control unit 22 sets the notification of incoming calls from the first wireless communication device 10 in the second wireless communication device 14 according to the message and stores the message in the memory module 24. For example, when the multimedia datum of the message is an image datum, the control unit 22 can set the notification of incoming calls from the first wireless communication device 10 as that the display monitor 18 displays the image datum. When the multimedia datum of the message is an ringtone datum, the control unit 22 can set the notification of incoming calls from the first wireless communication device 10 as that the speaker 20 plays the ringtone datum. When the wireless communication module 12 of the second wireless communication device 14 receives the incoming call from the first wireless communication device 10, the control unit 22 controls the notification module 16 to execute the notification of incoming calls according to the setup mentioned above. For instance, the control unit 22 controls the display monitor 18 to display the image datum or controls the speaker 20 to play the ringtone datum so as to present the notification of incoming calls from the first wireless communication device 10.

In contrast to the conventional method for informing of an incoming call and related wireless communication device, the present invention can set a notification of incoming calls from other wireless communication devices in a wireless communication device according to a message transmitted from other wireless communication devices. That is, a caller can set a notification of incoming calls from the caller in a receiver's mobile phone. The user can personalize the notification of incoming calls of one's own in other user's mobile phone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for informing of an incoming call comprising:
(a) sending a message from a first wireless communication device to a second wireless communication device;
(b) setting a notification of incoming calls from the first wireless communication device in the second wireless communication device according to the message; and
(c) the second wireless communication device executing the notification of incoming calls from the first wireless communication device when the second wireless communication device receives an incoming call from the first wireless communication device.

2. The method of claim 1 wherein step (a) comprises the first wireless communication device sending a multimedia messaging service (MMS) message with a multimedia datum to the second wireless communication device.

3. The method of claim 2 wherein the multimedia datum is an image datum.

4. The method of claim 3 wherein step (b) comprises setting the notification of incoming calls from the first wireless communication device as displaying the image datum in the second wireless communication device and step (c) comprises the second wireless communication device displaying the image datum when the second wireless communication device receives the incoming call from the first wireless communication device.

5. The method of claim 2 wherein the multimedia datum is a ringtone datum.

6. The method of claim 5 wherein step (b) comprises setting the notification of incoming calls from the first wireless communication device as playing the ringtone datum in the second wireless communication device and step (c) comprises the second wireless communication device playing the ringtone datum when the second wireless communication device receives the incoming call from the first wireless communication device.

7. The method of claim 1 further comprising the second wireless communication device determining whether the message is a message for setting the notification of incoming calls from the first wireless communication device.

8. The method of claim 1 further comprising selecting whether the notification of incoming calls from the first wireless communication device is set in the second wireless communication device according to the message.

9. A wireless communication device for setting a notification of incoming calls from a first wireless communication device according to a message transmitted from the first wireless communication device, the wireless communication device comprising:
a wireless communication module for receiving the message transmitted from the first wireless communication device and an incoming call from the first wireless communication device;
a notification module for executing an notification of incoming calls; and
a control unit for controlling the notification module to execute the notification of incoming calls from the first wireless communication device according to the message transmitted from the first wireless communication device when the wireless communication module receives an incoming call from the first wireless communication device.

10. The wireless communication device of claim 9 wherein the message is a multimedia messaging service (MMS) message with a multimedia datum.

11. The wireless communication device of claim 10 wherein the multimedia datum is an image datum.

12. The wireless communication device of claim 11 wherein the notification module comprises a display monitor and the control unit controls the display monitor to display the image datum when the wireless communication module receives the incoming call from the first wireless communication device.

13. The wireless communication device of claim 10 wherein the multimedia datum is a ringtone datum.

14. The wireless communication device of claim 13 wherein the notification module comprises a speaker and the control unit controls the speaker to play the ringtone datum when the wireless communication module receives the incoming call from the first wireless communication device.

15. The wireless communication device of claim 9 further comprising a memory module for storing the message.

16. The wireless communication device of claim 9 being a mobile phone.
